(19) United States
(12) Patent Application Publication
(10) Pub. No.: US 2006/0050676 A1
(43) Pub. Date: Mar. 9, 2006

(54) System and method for a hybrid 1xEV-DO forward link

(75) Inventor: Nagi A. Mansour, Arlington, VA (US)

Correspondence Address: CROWELL & MORING LLP;INTELLECTUAL PROPERTY GROUP, P.O. BOX 14300, WASHINGTON, DC, 20044-4300, US

(73) Assignee: Nextel Communications, Inc., Reston, VA (US)

(21) Appl. No.: 11/200,212

(22) Filed: Aug. 10, 2005

Related U.S. Application Data
(60) Provisional application No. 60/608,129, filed on Sep. 9, 2004.

(51) Int. Cl. H04B 7/216

(52) U.S. Cl. 370/342; 370/335

(57) ABSTRACT

A system and method for a hybrid 1× evolution data only (1×EV-DO) forward link are provided. The data channels of a 1×EV-DO forward link are transmitted using Orthogonal Frequency Division Multiplexing (OFDM), while pilot and Medium Access Control (MAC) channels are transmitted using Code Division Multiple Access (CDMA). The pilot and MAC channels can use CDMA in one time slot and OFDM in another time slot.

### CROSS-REFERENCE TO RELATED APPLICATIONS

This application claims the benefit of U.S. Provisional Application No. 60/608,129, filed Sep. 9, 2004, the entire disclosure of this application is herein expressly incorporated by reference.

### BACKGROUND OF THE INVENTION

In a forward link frame of a United States Code Division Multiple Access (CDMA) technology, which is based on the Interim Standard 95 (IS-95) and the CDMA2000 standard for cellular communications, there are two types of channels: 1) common channels that are used to set up the call, namely Pilot, Paging and Synchronization channels; and 2) traffic channels that are used to carry user information from a base station to a mobile station.

For each channel, the system assigns a Walsh Code to uniquely identify each channel. Walsh codes are one of a group of specialized pseudonoise (PN) codes that have good autocorrelation properties, while exhibiting low levels of cross-correlation. Since Walsh codes are orthogonal mathematical codes, if two Walsh codes are correlated, the result is intelligible only if the two codes are the same. For IS-95/CDMA2000, there are 64 Walsh orthogonal codes, Walsh code W0 is assigned to the pilot channel, Walsh code W1 is assigned to the paging channel, Walsh code W32 is assigned to the synchronization channel, and Walsh codes W2 to W31 and W33 to W63 are assigned to traffic channels.

Each Walsh code is unique and is used to spread the information bits to make 1.2288 Mchips (1.2288 MHz), where “chips” refers to binary digits transmitted over an RF link. The art of separating the users (i.e., traffic channels) by codes is called Code Division Multiple Access (CDMA), which is also referred to as a CDM mode.

1× evolution data only (1×EV-DO) is a data only mobile telecommunications standard, which was developed based upon the CDMA2000 standard. A forward link frame of the 1×EV-DO standard is a downlink frame of data from a base station to a mobile station in a telecommunications system. Currently, in 1×EV-DO, the user is assigned a single time slot of 1.67 ms. Within this time slot, the data (information) bits (traffic information=user information) are spread using Walsh codes, as described below. FIG. 1 illustrates a ½ time slot of the 1×EV-DO forward link, including data chips, Medium Access Control (MAC) chips and pilot chips. The length of the time slot is 1.67 ms. Mobile stations use the pilot to sync with a base station. The two MACs are used for control purposes. The data portion of the traffic channel is used to carry the user information.

Each data portion has 400 chips (total 800/half time slot), the pilot is carried by Walsh code zero of length 64, and the two MACs are carried using two Walsh codes of length 64. For example, in FIG. 1, the 400 chips will be divided by 16 to result in 25 chips/code. Thus, every 25 chips are separated from each other using a Walsh code of length 16. In this case, all data carried by the 16 codes are given to one user. This is what is known in the art as a CDM mode, wherein, inside each time slot, each 25 chips are assigned one unique Walsh code. Each time slot is handled separately, and in the prior art every part of the time slot is carried either by one Walsh code or by 16, as in the data part. The orthogonality of the Walsh codes here depends on how successfully the information carried by the Walsh codes can be retrieved. However, over-the-air Walsh codes can lose orthogonality, which makes it hard to separate the correct information. For more information regarding 1×EV networks, the interested reader should refer to “Capacity Simulation of cdma2000 1×EV Wireless Internet Access System” by Black et al. or “1×EV:1×EVolution IS-856 TIA/EIA Standard Airlink Overview.” The entire disclosure of the aforementioned documents are herein expressly incorporated by reference.

### SUMMARY OF THE INVENTION

In accordance with exemplary embodiments of the present invention, data channels of a 1×EV-DO forward link are transmitted using Orthogonal Frequency Division Multiplexing (OFDM), while the pilot and MAC channels are transmitted using CDMA. In accordance with one aspect of the present invention, the pilot and MAC channels can use CDMA in one time slot and OFDM in another time slot.

Other objects, advantages and novel features of the present invention will become apparent from the following detailed description of the invention when considered in conjunction with the accompanying drawings.

### BRIEF DESCRIPTION OF THE DRAWINGS

FIG. 1 illustrates a ½time slot of the 1×EV-DO forward link;

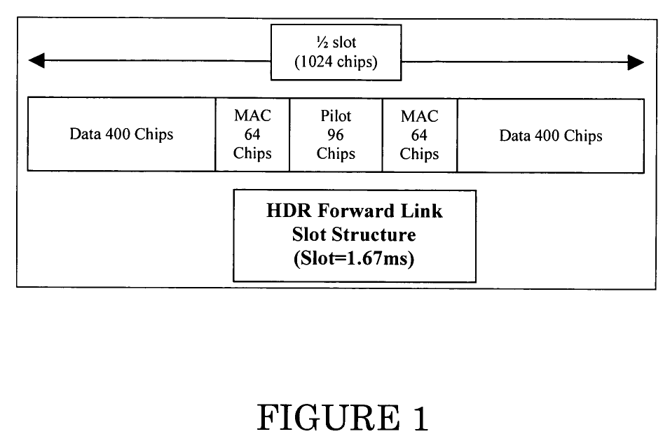

FIG. 2 illustrates user data carried by 16 Walsh codes;

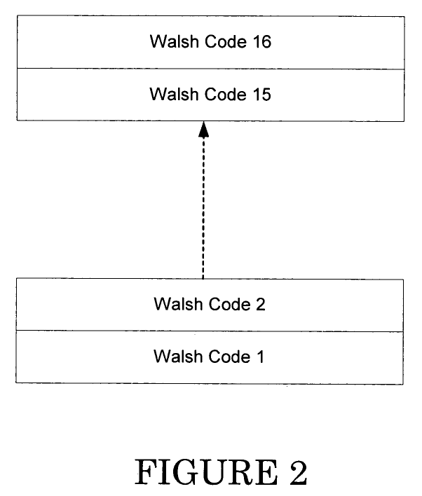

FIG. 3 illustrates user data carried by several tones in accordance with exemplary embodiments of the present invention;

FIG. 4 illustrates an exemplary wireless communication device for a hybrid 1×EV-DO forward link;

FIG. 5 illustrates an exemplary method according to the present invention; and

FIG. 6 illustrates an exemplary 400 chips of OFDM data.

### DETAILED DESCRIPTION OF THE EXEMPLARY EMBODIMENTS

Using an OFDM mode in a 1×EV-DO network to carry user information is a better technique for eliminating intra-cell interference than a CDM mode. Accordingly, using the OFDM mode of the present invention increases sector throughput. In exemplary embodiments of this invention, the data part that carries the information of every user in the forward link is carried over the air using an OFDM mode. The number of tones that will carry the user data can be easily determined.

In accordance with exemplary embodiments of the present invention, the use of Walsh codes in the traffic channel is replaced with an OFDM mode that consists of several tones. Accordingly, the data portion of the traffic channel will be carried using an OFDM mode. The number of OFDM tones depends on vendor implementation and can be determined using the following formula:
Width of tone KHz=Chip Rate (1228.8 Kb/s)/number of OFDM tones

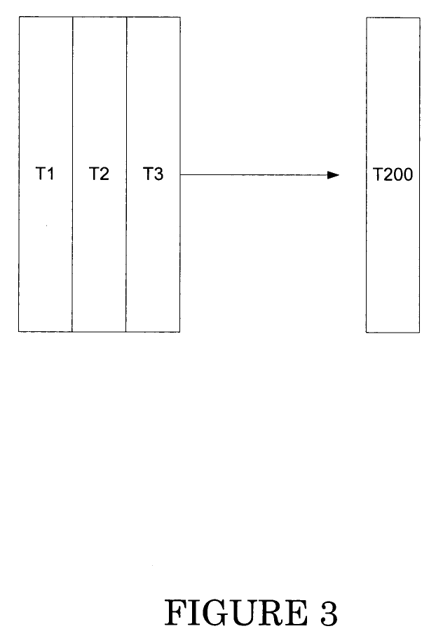

As illustrated in FIG. 3, in accordance with the present invention, the 400 data chips that are used to carry the information of the user (traffic information) from the base station to the mobile station are carried using a number of OFDM tones (Number of OFDM tones=1.2288 MHz/Tone spacing). For example, if the number of OFDM tones is 200 then the tone spacing=1228.8 KHz/200=6.14 KHz. Each OFDM tone will carry two bits. The information of each user is carried using 200 OFDM tones. Since the orthogonality between the OFDM tones is better than the orthogonality between the Walsh codes, one can achieve better performance using OFDM tones. For example, at least a doubling of data throughput may be achieved. This will result in better sector capacity by using OFDM tones in comparison to using Walsh codes to carry the traffic information. To maintain backward compatibility, the MAC and pilot channels may be carried by Walsh Codes.

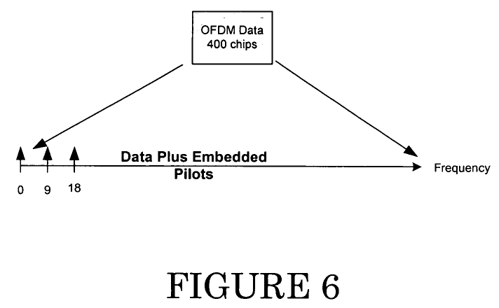

FIG. 6 illustrates an exemplary 400 chips of OFDM data. When the CDMA mode is replaced with OFDM symbols, the data will be carried on OFDM symbols instead the Walsh codes. Also, in a typical OFDM mode, pilot tones are inserted instead of data at selected places to perform channel estimation. The rest of the OFDM symbols will be used to carry the data. Hence, there will be in a data part, which usually carries user information, data and inserted pilot tones for proper channel estimation. As illustrated in FIG. 6, the pilot tones may be inserted every 10th symbol in the frequency domain. Thus, there are pilot tones at “0”, “9”, “18”, etc. in FIG. 6. Here, the OFDM pilot tones and the data are orthogonal. The number and position of inserted pilot tones can change depending upon the channel conditions and environment. FIG. 6 illustrates the embedded pilot tones, with the data therebetween.

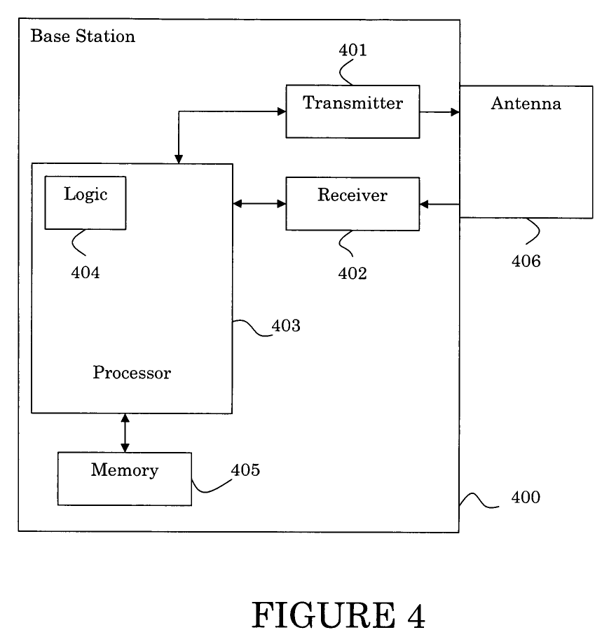

FIG. 4 illustrates an exemplary embodiment of a wireless communication device according to the present invention. As illustrated in FIG. 4, the wireless communication device may be a base station. The wireless communication device of FIG. 4 is a base station 400, which includes a transmitter 401, a receiver 402, a processor 403, a memory 405, and an antenna 406. The processor 403 can be a microprocessor, field programmable gate array (FPGA), application specific integrated circuit (ASIC) and/or the like. Memory 405 is coupled to the processor 403 and can store information for the processor and/or include a program for operation of the processor. Memory 405 can be read-only memory, random access memory, flash memory, a hard drive and/or the like. The processor 403 includes logic 404. In an exemplary embodiment of the present invention, the logic 404 controls the transmission of control channels using CDMA and the transmission of data channels using OFDM, for transmitting a 1×EV-DO forward link. Unicast transmission may be used for the transmission of control channels and data channels. Multi-cast transmissions may also be used.

To transmit the data channels using OFDM, rather than CDMA, a CDMA signal including the data channels may be transformed by a Fast Fourier Transform (FFT) or other transformation in the processor 403, for example, into an OFDM signal including the data channels. This OFDM signal including the data channels may then be transmitted.

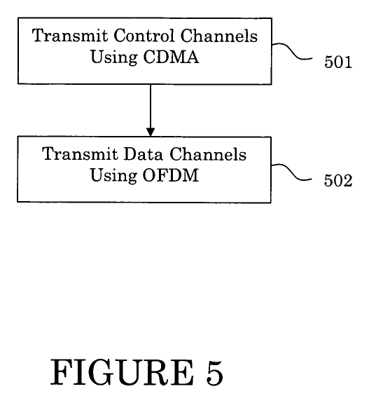

FIG. 5 illustrates an exemplary method in accordance with the present invention. As illustrated in the method of FIG. 5, the base station 400, using transmitter 401, processor 403, memory 405 and antenna 406, transmits control channels using CDMA (step 501) and transmits data channels using OFDM (step 502). In an exemplary embodiment of the method, the control channels may include pilot and MAC channels. The control channels may be transmitted in one time slot using CDMA and in another time slot using OFDM. The use of OFDM may include the use of OFDM tones. As described above, transmitting the data using OFDM tones instead of the Walsh codes of CDMA can result in improved throughput for the transmission.

According to another exemplary embodiment of the present invention, there is a computer-readable medium encoded with a computer program for transmitting a 1×EV-DO forward link, the computer program including instructions for: transmitting control channels using Code Division Multiple Access (CDMA); and transmitting data channels using Orthogonal Frequency Division Multiplexing (OFDM). The instructions associated with the computer-readable medium are described above, in relation to FIG. 5. The term “computer-readable medium” as used herein refers to any medium that participates in providing instructions for execution. Such a medium may take many forms, including but not limited to, non-volatile media, volatile media, and transmission media. Non-volatile media includes, for example, optical or magnetic disks. Volatile media includes, for example, dynamic memory. Transmission media includes coaxial cables, copper wire and fiber optics. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave, or any other medium from which a computer can read.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for transmitting a forward link from a base station to a mobile station, the method comprising the acts of:
transmitting control channels using Code Division Multiple Access (CDMA); and
transmitting data channels using Orthogonal Frequency Division Multiplexing (OFDM).

2. The method of claim 1, wherein the control channels are transmitted using the CDMA in one time slot and are transmitted using the OFDM in another time slot.

3. The method of claim 1, wherein using the OFDM comprises using OFDM tones.

4. The method of claim 3, wherein a number of the OFDM tones used equals 1.2288 MHz/tone spacing.

5. The method of claim 1, wherein the control channels comprise pilot and Medium Access Control (MAC) channels.

6. The method of claim 1, wherein the transmitting of control channels and data channels comprises unicast transmission.

7. A computer-readable medium encoded with a computer program for transmitting a forward link from a base station to a mobile station, the computer program comprising instructions for:
transmitting control channels using Code Division Multiple Access (CDMA); and
transmitting data channels using Orthogonal Frequency Division Multiplexing (OFDM).

8. The computer-readable medium of claim 7, wherein the control channels are transmitted using the CDMA in one time slot and are transmitted using the OFDM in another time slot.

9. The computer-readable medium of claim 7, wherein using the OFDM comprises using OFDM tones.

10. The computer-readable medium of claim 9, wherein a number of the OFDM tones used equals 1.2288 MHz/tone spacing.

11. The computer-readable medium of claim 7, wherein the control channels comprise pilot and Medium Access Control (MAC) channels.

12. The computer-readable medium of claim 7, wherein the transmitting of control channels and data channels comprises unicast transmission.

13. A base station processor, comprising:
logic for controlling transmission of control channels using Code Division Multiple Access (CDMA); and
logic for controlling transmission of data channels using Orthogonal Frequency Division Multiplexing (OFDM).

14. The base station processor of claim 13, wherein the control channels are transmitted using the CDMA in one time slot and are transmitted using the OFDM in another time slot.

15. The base station processor of claim 13, wherein using the OFDM comprises using OFDM tones.

16. The base station processor of claim 15, wherein a number of the OFDM tones used equals 1.2288 MHz/tone spacing.

17. The base station processor of claim 13, wherein the control channels comprise pilot and Medium Access Control (MAC) channels.

18. The base station processor of claim 13, wherein the transmission of control channels and data channels comprises unicast transmission.

19. A wireless communication device, comprising:
a transmitter which transmits controls channels and data channels; and
a processor including logic for controlling transmission of the control channels and the data channels, wherein the control channels are transmitted using Code Division Multiple Access (CDMA) and the data channels are transmitted using Orthogonal Frequency Division Multiplexing (OFDM).

20. The wireless communication device of claim 19, wherein the control channels are transmitted using the CDMA in one time slot and are transmitted using the OFDM in another time slot.

21. The wireless communication device of claim 19, wherein using the OFDM comprises using OFDM tones.

22. The wireless communication device of claim 21, wherein a number of the OFDM tones used equals 1.2288 MHz/tone spacing.

23. The wireless communication device of claim 19, wherein the control channels comprise pilot and Medium Access Control (MAC) channels.

24. The wireless communication device of claim 19, wherein the transmission of control channels and data channels comprises unicast transmission.
